(19) United States
(12) Patent Application Publication
(10) Pub. No.: US 2002/0175537 A1
(43) Pub. Date: Nov. 28, 2002

(54) Vehicle strengthening method and apparatus

(76) Inventor: Steven B. Cress, Glenbrook, NV (US)

Correspondence Address: Herbert C. Schulze, 2790 Wrondel Way, PMB 36, Reno, NV, 89502, US

(21) Appl. No.: 09/825,421

(22) Filed: Apr. 2, 2001

(51) Int. Cl. B60J 7/00

(52) U.S. Cl. 296/188

(57) ABSTRACT

This is a method and apparatus specifically directed to strengthening vehicle elements subject to possible bending forces during a vehicle accident. The method consists of forming hermetically sealed elongate hollow support members filled with air, or other fluid, under pressure so as to prestress them in such manner that they are under tension and resist bending and crushing in an accident, and mounting such support members in conjunction with various vehicle elements. In alternate embodiments, the elongate hollow support members may divided into multiple compartments, and the tube may be placed under compressive as well as tensile forces.

### CROSS REFERENCE TO RELATED PATENT APPLICATIONS

This Application is related to my applications Ser. No. 09/301,809 filed Apr. 28, 1999, now ______, and Ser. No. ______, filed Nov. 22, 2000, now ______.

### BACKGROUND OF THE INVENTION

I. Field of the Invention

This invention is in the general field of vehicle structures;

The invention is more particularly directed to a method and apparatus for strengthening and preventing buckling of the bodies or other parts of vehicles;

The invention is most particularly directed to a new, unique, novel, and useful method and apparatus for strengthening and reinforcing vehicles, and most particularly automotive vehicles and their various components such as, but not limited to, doors, frameworks, hoods, trunks and other compartments, fire-walls, bumpers, roofs, floors, windows, and the like.

II. Description of the Prior Art

The subject of passenger safety in vehicles is of continuing interest, and the subject of much research and development. There have been attempts to utilize heavy roll bars in racing cars and trucks. There have been many air-bag developments, seat belt and shoulder harnesses and the like. While some of these developments have been of assistance in protecting passengers, all such attempts have been less than fully effective and many have resulted in greatly increased cost and weight of the vehicle. In some cases, protective attempts have actually caused increased risk for some passengers, particularly infants and frail individuals.

I have studied this problem and have investigated commercially available vehicles and their safety apparatus. I have examined literature and news reports regarding the danger (and the many fatalities) resulting, particularly, from SUV (Sport Utility Vehicle) accidents and all other vehicular accidents

I have, also, reviewed Patent Libraries, and the like. I have found many patents which attempt to do some things to protect passengers from crushed vehicle components.

While my inventions referred to in this field are important, I have continued to pursue research into the desired goal of protecting passengers without materially affecting vehicle design, appearance, and cost. I have studied all of the art and the latest developments of others. As a result of my continued research, I have now developed an overall extension of my theories. It was previously not obvious to me, nor apparently to others, that I was developing a radical theory of vehicular design which can even reduce the cost and weight of a vehicle while providing greatly enhanced distortion resistance of the vehicle body and other vehicle parts.

Based upon my investigation and work in this field I have concluded that there is no prior art as to my present invention. The closest thing to prior art is that revealed in my two patent applications referred to above. However, in a sense, they are not prior art, since it required a great deal of work on my part to conceive my present development.

### SUMMARY OF THE INVENTION

I have studied the structure of vehicle roofs, doors, windows, fire-walls, trunks, engine compartments, and virtually all components of vehicles, particularly automotive vehicles. I have found that nearly all vehicles are constructed in similar fashion. The vehicle components are normally sheet metal, plastic, or the like formed into various shapes, frequently with ridges, various curved portions, and the like, designed to impart some strength to the components. In some cases hollow metal posts, or channels, are used to impart some additional strength. In an accident the support posts or other shaped components may bend and buckle. Particularly in a rollover or a severe side impact and the like the customary support posts and the like may even become dangerous for the occupants since they may make it impossible for passengers to escape from the vehicle and may actually pin, or trap, the occupants due to their permanent distortion.

I devised and considered many different vehicle structures to determine the optimum safe, practical, and support configuration. I have now discovered that I can remarkably enhance the safety of any vehicle or portion thereof. I accomplish this by pre-stressing hollow tubes with compressed air or other fluids.

I form hollow tubes, or the like, of light weight metal, plastic, or the like. I then close the ends of the tubes, install a valve or the like in a tube wall. The wall in which I install the valve is usually, but not necessarily, an end closure of an elongated tube. I then pressurize the tube by introduction of air under pressure into the tube. Experiments I have performed show that the pressurized tubes resist bending when exposed to a bending force or any sudden impact. The bending force can be exerted by a direct point of contact, or indirectly by crushing of a component with which the tube is associated.

While I contemplate air as being the most economical fluid to use in pre-stressing vehicle support members, there may be special reasons for using other fluids in place of air. One example would be the use of fluids which will not support combustion, perhaps with a pop off valve, so that at a certain point the fluid could be released as a fire suppressant.

It is an object of this invention to strengthen vehicle components;

Another object of this invention is to provide a vehicle component support system by the use of light weight tubular members containing fluid under pressure sufficient to resist bending, buckling, or distortion under impact.

Another object is to provide such a support system which will, also, have fire suppressant qualities.

The foregoing and other objects and advantages of this invention will be understood by those skilled in the art upon reading the description of a preferred embodiment, which follows, in conjunction with a review of the appended drawings.

### BRIEF DESCRIPTION OF THE DRAWINGS

FIG. 1 is a schematic perspective of a passenger vehicle showing some of areas of the vehicle which can be protected by the methods of this invention

FIG. 2 is a schematic perspective of a passenger vehicle door panel equipped with hollow, pressurized support members suitable to practice the methods of this invention;

FIG. 3 is an enlarged schematic exploded view of support member 46 in FIG. 2, suitable to practice the method of this invention;

FIG. 4 is a schematic exploded view an alternate embodiment of the support member of FIG. 3;

FIG. 4A is a schematic view of a method of attaching wire illustrated in FIG. 4; and

FIG. 5 is a schematic exploded, partially broken away, view of another alternate embodiment of the support member of FIG. 3.

### DESCRIPTION OF A PREFERRED EMBODIMENT

An inventory of items bearing reference numerals is:

| Numeral | Item Description |
|---|---|
| 10 | vehicle |
| 20 | left door and window assembly |
| 22 | door exterior panel |
| 24 | door hinges |
| 26 | window |
| 30 | vehicle side panel |
| 40 | hollow support member of this invention |
| 42 | hollow support member of this invention |
| 44 | hollow support member of this invention |
| 46 | hollow support member of this invention |
| 46a | hollow tube |
| 46b | first end closure |
| 46c | hole for valve |
| 46d | valve |
| 46e | second end closure |
| 48 | hollow support member of this invention |
| 146 | first alternate embodiment of hollow support |
| | member |
| | of this invention |
| 146a | hollow tube |
| 146b | first end closure |
| 146c | hole for valve |
| 146d | valve |
| 146e | second end closure |
| 147 | tension wire |
| 147a | intermediate connecting wire |
| 147b | intermediate connecting wire |
| 147c | connection of wire 147a to end closure |
| 147d | connection of wire 147b to end closure |
| 147e | connection of wires 147, 147a, and 147b |
| 150 | wire passing through hole in end closure |
| 152 | wire connection to end closure |
| 246 | second alternate embodiment of hollow support |
| | member |
| | of this invention |
| 246a | hollow tube |
| 246b | first end closure |
| 246c | hole for valve |
| 246d | valve |
| 246e | second end closure |
| 247 | tension wire |
| 247a | intermediate connecting wire |
| 247b | intermediate connecting wire |
| 247e | connection of wires 147, 147a, and 147b |
| 250 | wire passing through hole in end closure |
| 260 | discs |

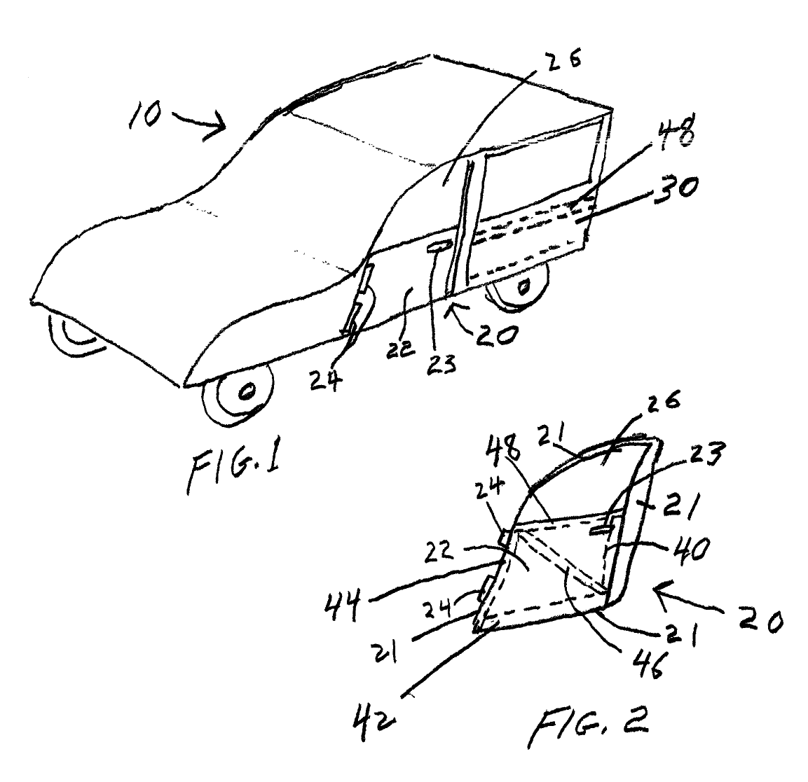

FIG. 1 illustrates, schematically, a vehicle 10 having a door 20, rear side panel 30 and other features known to those skilled and unskilled in the art. The details of the vehicle are not shown, since these are known to those skilled in the art and are not necessary to an understanding of the invention presented. The door 20 with various support members of this invention is shown in FIG. 2. A support member 48 is shown in FIG. 1. This support member will protect panel 30 from serious distortions.

FIG. 2 shows a door 20 having a frame 21 of customary construction, known to those skilled in the art, completely surrounding the door and window assembly 20.

The hood, roof, door panels and the like are normally made of rigid materials such as sheet metal or the like which will be shaped by means known to those skilled in the art.

FIG. 2 shows the door and window assembly 20 comprising frame 21, door panel 22, window 26, door handle 23, and hinges 24. There are normally other parts of the door and window assembly which are not illustrated here, since they are not pertinent to an understanding of the present invention.

In FIG. 2, support members of this invention 40, 42, 44, 46, and 48 are shown. These support members are welded, or otherwise secured in place by means known to those skilled in the art. As shown, it will be clear to those skilled in the art, that if the support members 40, 42, 44, 46, and 48 are welded solidly in place and if they do not bend, the integrity of the door will be greatly enhanced in an accident. It is of course the “not bending” which is critical. The structure and pre-stressing of the support members is the heart of this invention, and it is that which causes the support members of this invention to be so unusual and so valuable and useful.

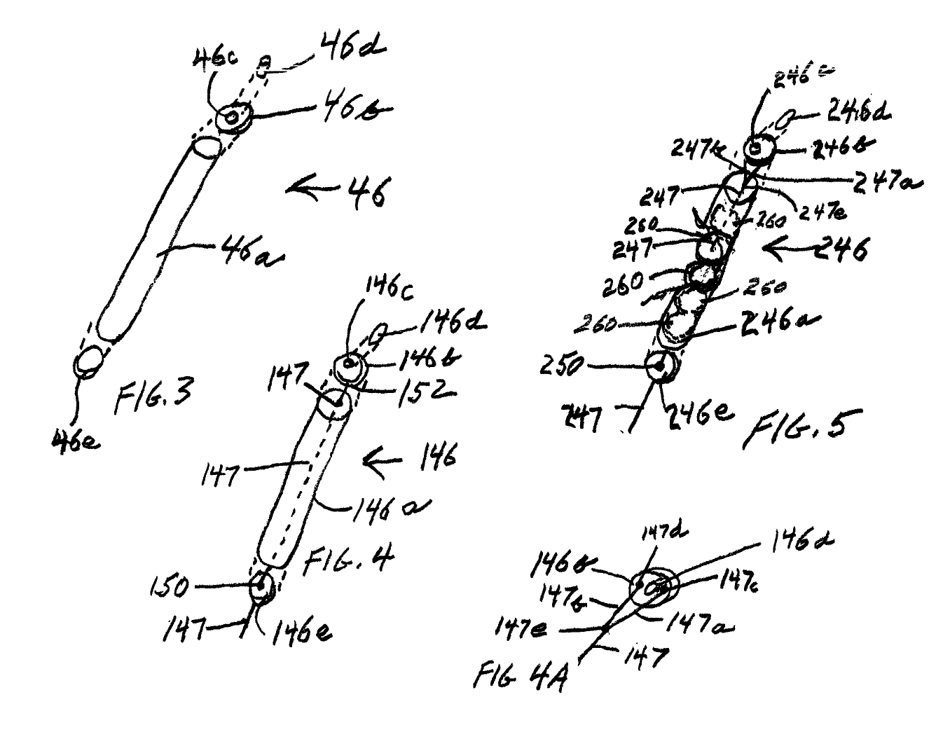

FIG. 3 shows the structure of support member 46. All of the other support members will have the same structure. In use, the end closures 46b and 46e and valve 46d will be welded or otherwise hermetically sealed in place in the ends of tube 46a to complete the structure of the support member 46. A source of air pressure such as a compressor or the like will be used to introduce air or other appropriate fluid into the hollow support member through the valve 46d, as will be understood by those skilled in the art. When pressurized, the support member 46 will resist bending when subjected to forces such as will occur in an accident or the like. Valve 46d may also be used to check pressure and to re-pressurize from time to time, should that be desirable. The exact pressure which will give the best results may be determined, preferably empirically, for different portions of the vehicle in order to create maximum stability. Under any circumstance, it is understood that the pressure within the support members will be greater than the ambient atmospheric pressure exterior of the support member. This will be understood by those skilled in the art.

In the event it is difficult to make the support members impermeable by one practicing the method of this invention, an elongate bladder, or the like, could be placed within the support members, and the bladder be inflated within the support member to ensure both the pressure and impermeability, as will be understood by those skilled in the art.

Pressurization of the support members may be accomplished by various means which will be understood by those skilled in the art. It can be by explosive charges, by compressor, and the like. The exact means of pressurization can be a matter of choice for each individual case and user.

FIG. 4 is an exploded view of an alternate embodiment of a support member 146 similar to the one shown in FIG. 3. In this case, one or more tension wires, or the like, 147 will be connected by welding or other suitable means at 152 to the inside of end closure 146b. If desired, in order to center the effective connection at 152, there can be two or more connections in the nature of a net around the valve 146d as shown in FIG. 4A. Wires 147a and 147b are fastened respectively at 147c and 147d to the underside of end closure 146b. Wires 147, 147a, and 147b are connected at 147e This will be understood by those skilled in the art. The wire 147 continues through the hollow tube 146a and through the end closure at 150. During assembly the wire 147 will be pulled through the end closure 146e under tension so as to put the hollow tube 146a into compression. When the desired tension on the wire 147 is reached, the wire will be welded, or otherwise affixed to the end closure 146e so that the wire remains under tension and the hollow tube 146a is under compression. Thereafter the hollow tube is filled with compressed air or the like through valve 146d. This results in a superior pre-stressed support member 146.

Alternatively, the compression of the hollow tube 146b caused by tension on the wire will test the integrity of the tube 146a. In the event there should be scratches or other defects in the tube it may fail under the tension of the wire. In this event the tube can be replaced before final assembly and tensioning by compressed fluid.

FIG. 5 illustrates one more alternate embodiment. In this case there will be a number of discs 260 which are very nearly the same diameter as the interior diameter of the tube 246a. Any clearance will be very minute, and will be just sufficient to allow proper pressurization of the tube 246a as previously described for tube 146a. The discs will be fastened to the wire 247 and will be relatively closely spaced. Since the discs are very nearly the exact size of the inner diameter of the tube they will remain relatively perpendicular to the wire 247. The wire may be placed under tension as previously described for wire 147 or under a lighter tension, if desired. The use of the discs will create maximum rigidity of the tube 246a, when combined with the effect of the fluid prestressing.

While I have not illustrated it, a customary vehicle roll bar could be modified to utilize the principles of this invention. A roll bar would be constructed of impermeable tubular material, with ends being hermetically sealed and a valve or other suitable means for introducing fluid into the tubular interior of the roll bar under pressure greater than the ambient pressure on the exterior of the roll bar. This will produce a roll bar with strength and rigidity greater than a similar roll bar without the pressurized fluid. The roll bar of this invention will be connected to the chassis/body of the vehicle in a customary manner. While I have not illustrated this roll bar, illustration is unnecessary for those skilled in the art, who will understand this completely.

Throughout the foregoing specification, and in the claims which follow, I may have illustrated support members with a particular interior shape such as cylindrical or the like. It is to be understood that the hollow support members may be of any cross-sectional shape such as circular, triangular, hexagonal, oval, or any other conceivable shape. All hollow support members which might be formed, regardless of cross section and whether or not of uniform cross section, are intended to be included in this teaching and invention.

In the claims which follow, if I omit, or fail to claim, one of the inventive features disclosed or suggested in this application, such failure will be inadvertent and is not intended to be an indication that I have abandoned or dedicated such feature. If such should happen, it is my intent to cure the defect by reissue or other appropriate means when I discover any such omission or failure.

While the embodiments of this invention specifically shown and described are fully capable of achieving the objects and advantages desired it is to be understood that such embodiments are for purposes of illustration only and not for purposes of limitation.

I claim:

1. The method for creating a vehicle support member comprising: affixing ends to an elongate hollow tube in such manner as to form a closed elongate hollow tube; installing a fluid valve into the closed elongate hollow tube; and pre-stressing the closed elongate hollow tube by pressurizing the interior of the closed elongate hollow tube through said valve with a fluid under pressure greater than the ambient pressure exterior the closed elongate hollow tube.

2. The method of claim 1 wherein the pressurizing is accomplished by filling the vehicle support member with a fluid which will not support combustion under pressure greater than the ambient air pressure exterior of the vehicle support member.

3. The method for making a vehicle resistant to accident damage comprising: forming a multiplicity of pressurized hollow support members; and mounting said pressurized hollow support members upon vehicle elements which are susceptible to deformation in the event of an accident.

4. A vehicle support member comprising: an elongate hollow tube containing fluid at a pressure greater than the ambient pressure exterior said elongate hollow tube.

5. A vehicle support member comprising: an elongate hollow tube having a first end and a second end; tension means connecting said first end and said second end in such manner that said elongate hollow tube is placed in compression between the said first and second ends; and fluid at a pressure greater than the ambient pressure exterior said elongate hollow tube filling said elongate hollow tube.

6. A vehicle support member comprising: an elongate hollow tube having a first end and a second end; tension means connecting said first end and said second end in such manner that said elongate hollow tube is placed in compression between the said first and second ends; a plurality of disc means of approximately the same shape and dimensions as the interior cross sectional shape and dimensions of the elongate hollow tube dividing the interior of the tube into a multiplicity of compartments, but not hermitically sealing the interior of the elongate hollow tube into a multiplicity of sealed compartments, and fluid at a pressure greater than the ambient pressure exterior said elongate hollow tube filling said elongate hollow tube and each of the multiplicity of compartments.

7. A vehicle roll bar comprising: an elongate impermeable tubular member in the form of an inverted “U” having a first straight segment with a first closed end, a second straight segment having a first closed end, and a curved segment intermediate said first and second ends; fluid means under pressure greater than the ambient pressure exterior of said impermeable tubular member filling said elongate tubular member; and means connecting said impermeable tubular member to a vehicle.
